(19) United States
(12) Patent Application Publication
(10) Pub. No.: US 2025/0044519 A1
(43) Pub. Date: Feb. 6, 2025

(54) MICRO-MOLDED PRISM GEOMETRIC WAVEGUIDE

(71) Applicant: Meta Platforms Technologies, LLC, Menlo Park, CA (US)

(72) Inventor: Kurt Jenkins, Sammamish, WA (US)

(21) Appl. No.: 18/396,353

(22) Filed: Dec. 26, 2023

Related U.S. Application Data
(60) Provisional application No. 63/517,221, filed on Aug. 2, 2023.

(51) Int. Cl. G02B 6/34

(52) U.S. Cl. CPC G02B 6/34

(57) ABSTRACT

A method of manufacturing a micro-molded prism geometric waveguide includes forming a first transflective mirror element and a separate second transflective mirror element, forming a first functional coating over an active surface of the first transflective mirror element, forming a second functional coating over an active surface of the second transflective mirror element, and aligning the first transflective mirror element with the second transflective mirror element to form a microprism array.

### CROSS-REFERENCE TO RELATED APPLICATION

This application claims the benefit of priority under 35 U.S.C. § 119(e) of U.S. Provisional Application No. 63/517,221, filed Aug. 2, 2023, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an isometric view of the active portion of a geometric waveguide according to some embodiments.

FIG. 2 shows the formation of an optical coating over the active surfaces of a plurality of micro-molded prisms according to certain embodiments.

FIG. 3 is an exploded view showing an arrangement of singulated prism mirrors according to some embodiments.

FIG. 4 depicts a mirror assembly including a plurality of micro-molded prisms according to various embodiments.

FIG. 5 is a cross-sectional view of a micro-molded prism assembly and its co-integration with a reflective polarizer according to some embodiments.

FIG. 6 is an illustration of exemplary augmented-reality glasses that may be used in connection with embodiments of this disclosure.

FIG. 7 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Virtual reality and augmented reality devices and headsets typically include an optical system having a microdisplay and imaging optics. The microdisplay is configured to provide an image to be viewed either directly or indirectly using, for example, a micro OLED display or by illuminating a liquid-crystal based display. Display light may be projected to the eyes of a user using a waveguide where the light is in-coupled into the waveguide, transported therethrough by total internal reflection (TIR), and out-coupled when reaching the position of a viewer's eye.

In some systems, the imaging optics may include a geometric waveguide. With a geometric waveguide, light from the optical engine is in-coupled typically through a reflective mirror or prism, and then transported by TIR to an array of transflective surfaces that are configured to reflect a portion of the light to the eye of a user and transmit a remaining portion of the light for further propagation. Transmitted light may encounter another transflective surface where the reflection and transmission paradigm is repeated.

A variety of challenges are associated with the manufacture of a geometric waveguide, including the coating and alignment of the transflective mirrors. For instance, because the light intensity incident on successive mirrors may decrease following each reflection and transmission event, the designed reflection/transmission ratio may be different for each mirror within a microprism array to ensure a uniform light output. Moreover, the use of polarized light, such as with a liquid crystal on silicon (LCOS) microdisplay, may dictate a complex coating architecture that includes a plurality of layers requiring multiple masking and deposition steps.

Notwithstanding recent developments, it would be advantageous to provide an economical process for the manufacture of a geometric waveguide that minimizes imperfections in a final virtual image, including non-uniformity, black lines, and ghost images. In accordance with various embodiments, a geometric waveguide includes active components such as an expansion element and a decoupling element that are independently manufactured and processed. Through the independent manufacture of the different waveguide components, the design specifications for each component can be separately addressed and individually met.

According to particular embodiments, by separately manufacturing the different transflective mirrors of a geometric waveguide, molding and coating operations can be tailored for each mirror and downstream assembly processes can include optimized alignment and placement, which may allow for batch processing, lower cost, and improved performance. Different transflective mirrors may be molded, coated, aligned and optically bonded to a carrier plate, for example. Index-matched optical bonding may be used to ensure acceptable transmissivity for augmented reality applications.

A geometric waveguide may include two or more prism elements that each contain a microprism array. In accordance with certain embodiments, the individual transflective mirrors constituting each array may be molded and coated independently, and then assembled to form the array architecture. Such an approach may enable localized functionality in each individual mirror and obviate the need for complex masking and coating processes to form a microprism array having a gradient structure. According to some embodiments, precision optomechanical locating features may be incorporated into each transflective mirror element to ensure accurate alignment.

The transflective mirrors may be molded from a suitable plastic material, such as polycarbonate, although further optical materials are contemplated. In some embodiments, plural transflective mirrors may be formed from the same material and may have equivalent or substantially equivalent refractive indices, whereas the geometry of the mirrors and/or the functional coatings applied thereto may be configured differently for each mirror within a microprism array.

A method of manufacturing a multi-part geometric waveguide may include forming a primary transflective mirror and a separate secondary transflective mirror, forming a functional coating over an active surface of the primary transflective mirror, forming a functional coating over an active surface of the secondary transflective mirror, and aligning and bonding the primary transflective mirror to the secondary transflective mirror to form a microprism array.

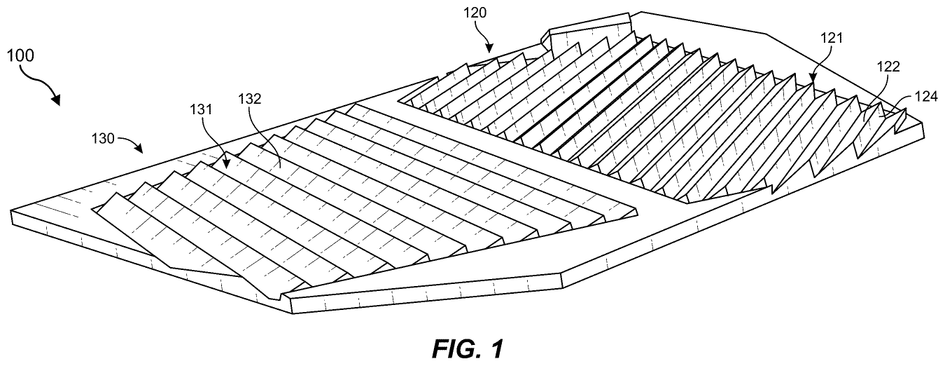

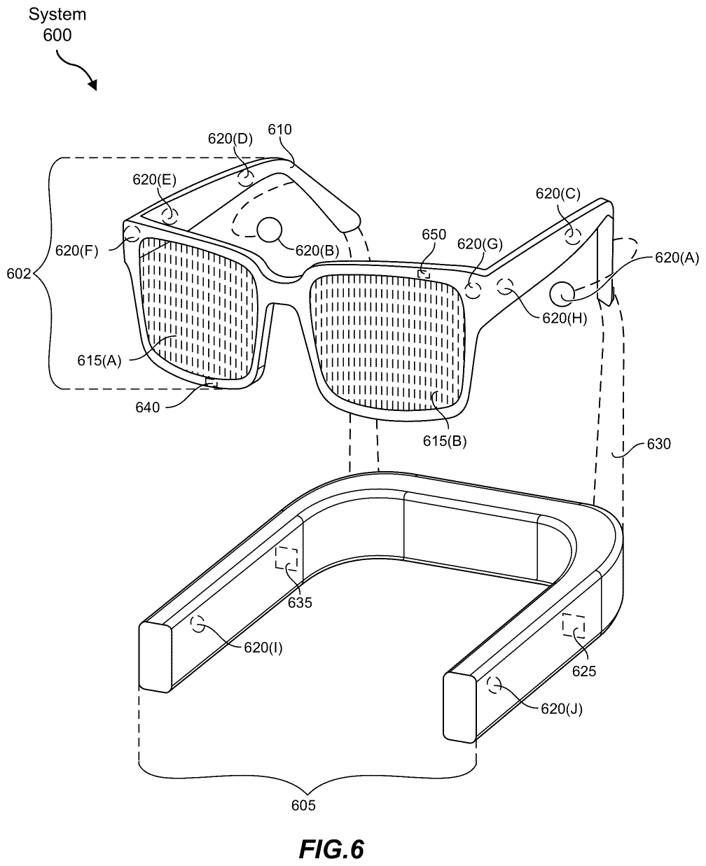

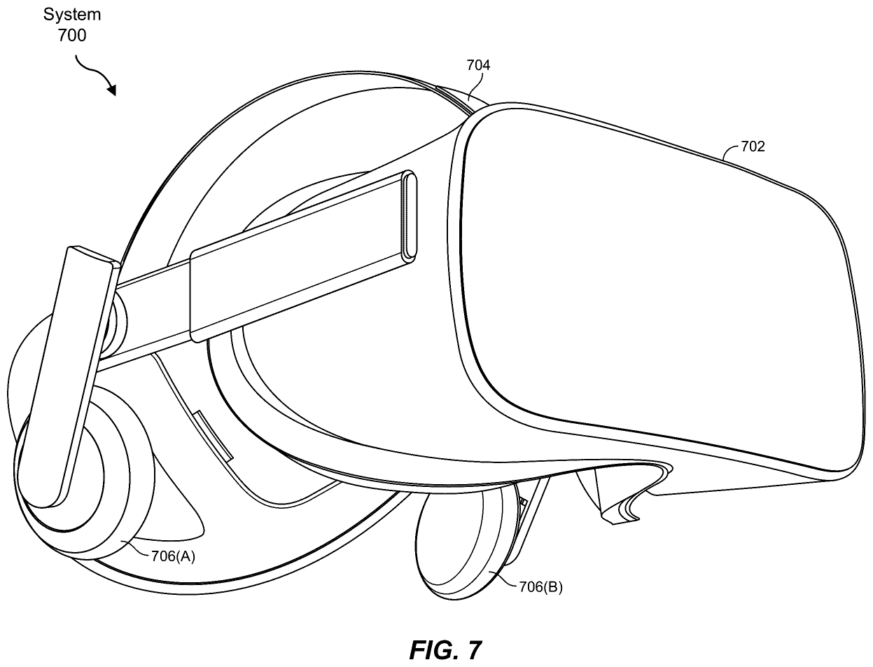

The following will provide, with reference to FIGS. 1-7, detailed descriptions of methods for manufacturing a micro-molded prism geometric waveguide. The discussion associated with FIGS. 1-5 includes a description of example waveguide components and assemblies, including their respective structures and methods of manufacture. The discussion associated with FIGS. 6 and 7 relates to exemplary virtual reality and augmented reality devices that may include one or more micro-molded prism geometric waveguides as disclosed herein.

Shown in FIGS. 1-4 are perspective views of a micro-molded prism geometric waveguide, which may include the independent design, manufacture, and integration of plural microprism mirrors. With reference to FIG. 1, the shape, including the flatness, and functionality of each facet within a pair of microprism arrays may be independently configured.

Micro-molded prism geometric waveguide 100 may include an input prism 110. Input prism 110 may be sized and dimensioned to direct image light into the waveguide. Input prism 110 may be formed from glass or a polymer, for example. Micro-molded prism geometric waveguide 100 additionally includes an expansion zone 120 and an out-coupling zone 130. Expansion zone 120 includes an array of prism elements 121 and out-coupling zone 130 includes an array of prism elements 131.

Expansion zone 120 is configured to extend a beam of image light entering the waveguide through input prism 110 along a first dimension. The illustrated prism elements 121 may be formed by molding and each may include an active surface 122 and a draft (i.e., inactive) surface 124. In certain embodiments, active surfaces 122 may be coated with a functional optical coating.

Out-coupling zone 130 is configured to expand the image light in a second dimension orthogonal to the first dimension and direct the expanded light to the eyes of a user. The illustrated prism elements 131 may be formed by molding and each may include an active surface 132 and a draft surface (not visible). In certain embodiments, active surfaces 132 may be coated with a functional optical coating. As will be appreciated, the design and manufacture of the prism elements 121 may be independent of the design and manufacture of the prism elements 131. Moreover, each prism element 121 within expansion zone 120 and each prism element 131 within out-coupling zone 130 may be independently designed and manufactured.

By separating the manufacture of the prism elements, component-specific features may be addressed on a per-part basis resulting in greater yield and higher performance. For instance, more economical processing, such as batch processing, may be utilized to form different functional coatings on the active surfaces of the respective prism elements.

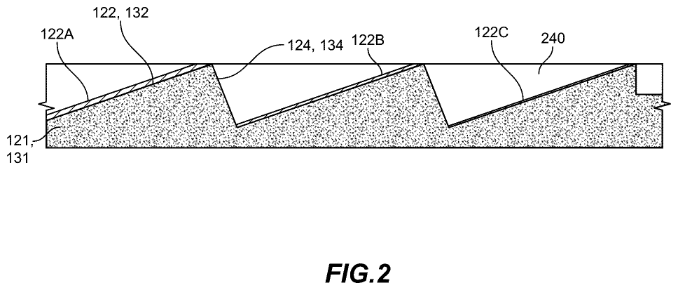

The formation and coating of individual mirrors using precision molding to form primary and secondary prism elements, for example, is shown in FIG. 2. Each active facet may be overcoated with an optical layer, and each optical layer may be independently configured. For instance, as shown in FIG. 2, a thickness of optical layer 122A may be greater than a thickness of optical layer 122B formed over the active surface of an adjacent facet, and a thickness of optical layer 122B may be greater than a thickness of optical layer 122C. A passive fill layer 240 may be formed over the coated facets. Fill layer 240 may include any suitable optical polymer and may be UV cured or thermally cured. The optical polymer constituting fill layer 240 may be index-matched with the underlying prism elements 121, 131.

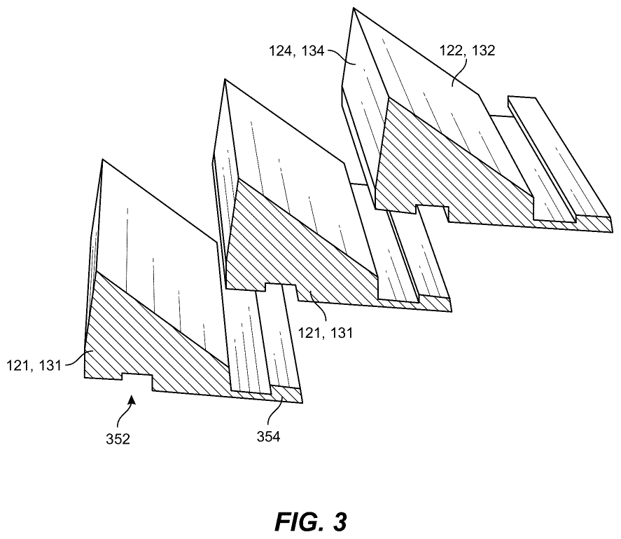

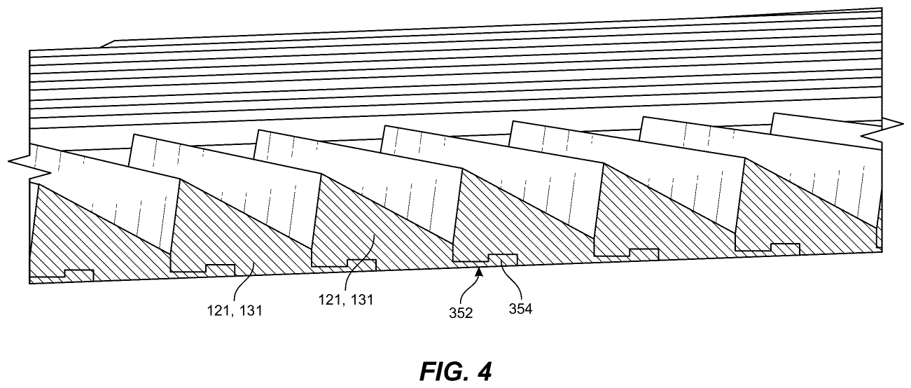

An exploded view of a microprism array showing individual facets is shown in FIG. 3, and a corresponding assembled microprism array is shown in FIG. 4. As described with reference to FIG. 1 and referring to FIG. 3, each prism element 121, 131 includes an active surface 122, 132 and an inactive (draft) surface 124, 134. Active surfaces 122, 132 may include an over-formed optical coating whereas inactive surfaces 124, 134 may remain uncoated.

In certain embodiments, the prism elements 121, 131 may include coupling features 352, 354. The coupling features may be configured to align and connect two or more prism elements 121, 131 to form an array. In the illustrated example, a female coupling feature 352 of a first prism element may engage a male coupling feature 354 of a second prism element to interconnect the first and second prism elements, as shown in FIG. 4.

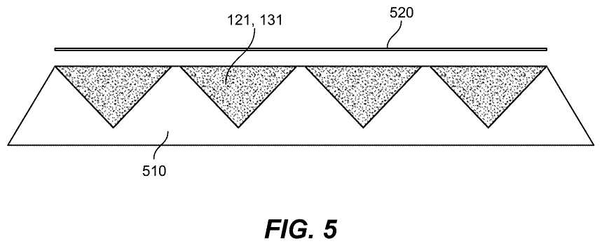

FIG. 5 is a cross-sectional view showing the co-integration of an optical coating with the active surface of each of a plurality of prism elements. Prism elements 121, 131 may be laid up or otherwise supported by a support fixture 510. Following lamination of the optical coating 520, the prism elements may be removed from the support fixture 510 and assembled to form a microprism array. The optical coating 520 may include a uniform or non-uniform dielectric layer, anti-reflective coating, reflective polarizer layer, etc. That is, micromirrors of prism elements 121, 131 may be coated equivalently or distinctly.

As disclosed herein, a geometric waveguide (GWG) having high optical efficiency has a modular construction where its constituent elements are manufactured separately and then assembled. An exemplary geometric waveguide may include an in-coupling element, an expansion element, and a decoupling element. The expansion element and the decoupling element may each include a microprism array formed from prism elements that are independently manufactured to their respective design specifications, coated with one or more functional layers, and then aligned and bonded. That is, each component in the GWG may be individually molded and coated, allowing for batch processing and lower cost. A molding process may include micro-injection molding. A coating process may include evaporation, for example, and may be used to form an antireflective coating or polarizing layer overthe facets of the mirrors within an expansion or decoupling element. By separately manufacturing the waveguide components, the manufacturing processes, including molding and coating, can be optimized for each component, and the assembly can be optimized for alignment and sizing to achieve a scalable, high yield method of manufacture.

### EXAMPLE EMBODIMENTS

Example 1: A method includes forming a first transflective mirror element and a separate second transflective mirror element, forming a first functional coating over an active surface of the first transflective mirror element, forming a second functional coating over an active surface of the second transflective mirror element, and aligning the first transflective mirror element with the second transflective mirror element to form a microprism array.

Example 2: The method of Example 1, where forming the first transflective mirror element and forming the second transflective mirror element include molding an optical polymer.

Example 3: The method of any of Examples 1 and 2, where a refractive index of the first transflective mirror element is substantially equal to a refractive index of the second transflective mirror element.

Example 4: The method of any of Examples 1-3, where forming the first transflective mirror element includes molding a first optical polymer and forming the second transflective mirror element includes molding a second optical polymer.

Example 5: The method of any of Examples 1-4, where forming the first and second functional coatings includes evaporative deposition.

Example 6: The method of any of Examples 1-5, where forming the first functional coating includes evaporative deposition in a first deposition process and forming the second functional coating includes evaporative deposition in a second deposition process.

Example 7: The method of any of Examples 1-6, where a thickness of the first functional coating differs from a thickness of the second functional coating.

Example 8: The method of any of Examples 1-7, where an angle of inclination of the active surface of the first transflective mirror element is different than an angle of inclination of the active surface of the second transflective mirror element.

Example 9: The method of any of Examples 1-8, where the first transflective mirror element and the second transflective mirror element are aligned using a mating coupling feature.

Example 10: The method of any of Examples 1-9, where the first transflective mirror element includes a female coupling feature, the second transflective mirror element includes a male coupling feature, and the first transflective mirror element and the second transflective mirror element are aligned by engaging the female coupling feature with the male coupling feature.

Example 11: The method of any of Examples 1-10, where the first functional coating includes a reflective polarizer having a first polarization response and the second functional coating includes a reflective polarizer having a second polarization response different from the first polarization response.

Example 12: A geometric waveguide includes an expansion zone including an array of independently-configured first transflective mirror elements, and an out-coupling zone including an array of independently-configured second transflective mirror elements.

Example 13: The geometric waveguide of Example 12, where each first transflective mirror element includes an active surface, and the active surfaces of the first transflective mirror element each include an optical coating.

Example 14: The geometric waveguide of Example 13, where a thickness of the optical coatings is different amongst the first transflective mirror elements.

Example 15: The geometric waveguide of any of Examples 13 and 14, where an angle of inclination of the active surfaces of the first transflective mirror elements are different.

Example 16: The geometric waveguide of Example 12, where each second transflective mirror element includes an active surface, and the active surfaces of the second transflective mirror element each include an optical coating.

Example 17: The geometric waveguide of Example 16, where a thickness of the optical coatings is different amongst the second transflective mirror elements.

Example 18: The geometric waveguide of any of Examples 16 and 17, where an angle of inclination of the active surfaces of the second transflective mirror elements are different.

Example 19: A geometric waveguide includes a first array of independently-configured transflective mirror elements and a second array of independently-configured transflective mirror elements.

Example 20: The geometric waveguide of Example 19, where the first array of independently-configured transflective mirror elements includes a plurality of facets, each facet having an active surface with an optical coating disposed over each active surface, and the second array of independently-configured transflective mirror elements includes a plurality of facets, each facet having an active surface with an optical coating disposed over each active surface.

Embodiments of the present disclosure may include or be implemented in conjunction with various types of artificial-reality systems. Artificial reality is a form of realitythat has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 600 in FIG. 6) or that visually immerses a user in an artificial reality (e.g., virtual-reality system 700 in FIG. 7). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 6, augmented-reality system 600 may include an eyewear device 602 with a frame 610 configured to hold a left display device 615(A) and a right display device 615(B) in front of a user's eyes. Display devices 615(A) and 615(B) may act together or independently to present an image or series of images to a user. While augmented-reality system 600 includes two displays, embodiments of this disclosure may be implemented in augmented-reality systems with a single NED or more than two NEDs.

In some embodiments, augmented-reality system 600 may include one or more sensors, such as sensor 640. Sensor 640 may generate measurement signals in response to motion of augmented-reality system 600 and may be located on substantially any portion of frame 610. Sensor 640 may represent a position sensor, an inertial measurement unit (IMU), a depth camera assembly, a structured light emitter and/or detector, or any combination thereof. In some embodiments, augmented-reality system 600 may or may not include sensor 640 or may include more than one sensor. In embodiments in which sensor 640 includes an IMU, the IMU may generate calibration data based on measurement signals from sensor 640. Examples of sensor 640 may include, without limitation, accelerometers, gyroscopes, magnetometers, other suitable types of sensors that detect motion, sensors used for error correction of the IMU, or some combination thereof.

Augmented-reality system 600 may also include a microphone array with a plurality of acoustic transducers 620(A)-620(J), referred to collectively as acoustic transducers 620. Acoustic transducers 620 may be transducers that detect air pressure variations induced by sound waves. Each acoustic transducer 620 may be configured to detect sound and convert the detected sound into an electronic format (e.g., an analog or digital format). The microphone array in FIG. 6 may include, for example, ten acoustic transducers: 620(A) and 620(B), which may be designed to be placed inside a corresponding ear of the user, acoustic transducers 620(C), 620(D), 620(E), 620(F), 620(G), and 620(H), which may be positioned at various locations on frame 610, and/or acoustic transducers 620(I) and 620(J), which may be positioned on a corresponding neckband 605.

In some embodiments, one or more of acoustic transducers 620(A)-(F) may be used as output transducers (e.g., speakers). For example, acoustic transducers 620(A) and/or 620(B) may be earbuds or any other suitable type of headphone or speaker.

The configuration of acoustic transducers 620 of the microphone array may vary. While augmented-reality system 600 is shown in FIG. 6 as having ten acoustic transducers 620, the number of acoustic transducers 620 may be greater or less than ten. In some embodiments, using higher numbers of acoustic transducers 620 may increase the amount of audio information collected and/or the sensitivity and accuracy of the audio information. In contrast, using a lower number of acoustic transducers 620 may decrease the computing power required by an associated controller 650 to process the collected audio information. In addition, the position of each acoustic transducer 620 of the microphone array may vary. For example, the position of an acoustic transducer 620 may include a defined position on the user, a defined coordinate on frame 610, an orientation associated with each acoustic transducer 620, or some combination thereof.

Acoustic transducers 620(A) and 620(B) may be positioned on different parts of the user's ear, such as behind the pinna, behind the tragus, and/or within the auricle or fossa. Or, there may be additional acoustic transducers 620 on or surrounding the ear in addition to acoustic transducers 620 inside the ear canal. Having an acoustic transducer 620 positioned next to an ear canal of a user may enable the microphone array to collect information on how sounds arrive at the ear canal. By positioning at least two of acoustic transducers 620 on either side of a user's head (e.g., as binaural microphones), augmented-reality device 600 may simulate binaural hearing and capture a 3D stereo sound field around about a user's head. In some embodiments, acoustic transducers 620(A) and 620(B) may be connected to augmented-reality system 600 via a wired connection 630, and in other embodiments acoustic transducers 620(A) and 620(B) may be connected to augmented-reality system 600 via a wireless connection (e.g., a Bluetooth connection). In still other embodiments, acoustic transducers 620(A) and 620(B) may not be used at all in conjunction with augmented-reality system 600.

Acoustic transducers 620 on frame 610 may be positioned along the length of the temples, across the bridge, above or below display devices 615(A) and 615(B), or some combination thereof. Acoustic transducers 620 may be oriented such that the microphone array is able to detect sounds in a wide range of directions surrounding the user wearing the augmented-reality system 600. In some embodiments, an optimization process may be performed during manufacturing of augmented-reality system 600 to determine relative positioning of each acoustic transducer 620 in the microphone array.

In some examples, augmented-reality system 600 may include or be connected to an external device (e.g., a paired device), such as neckband 605. Neckband 605 generally represents any type or form of paired device. Thus, the following discussion of neckband 605 may also apply to various other paired devices, such as charging cases, smart watches, smart phones, wrist bands, other wearable devices, hand-held controllers, tablet computers, laptop computers, other external compute devices, etc.

As shown, neckband 605 may be coupled to eyewear device 602 via one or more connectors. The connectors may be wired or wireless and may include electrical and/or non-electrical (e.g., structural) components. In some cases, eyewear device 602 and neckband 605 may operate independently without any wired or wireless connection between them. While FIG. 6 illustrates the components of eyewear device 602 and neckband 605 in example locations on eyewear device 602 and neckband 605, the components may be located elsewhere and/or distributed differently on eyewear device 602 and/or neckband 605. In some embodiments, the components of eyewear device 602 and neckband 605 may be located on one or more additional peripheral devices paired with eyewear device 602, neckband 605, or some combination thereof.

Pairing external devices, such as neckband 605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 600 may be provided by a paired device or shared between a paired device and an eyewear device, thus reducing the weight, heat profile, and form factor of the eyewear device overall while still retaining desired functionality. For example, neckband 605 may allow components that would otherwise be included on an eyewear device to be included in neckband 605 since users may tolerate a heavier weight load on their shoulders than they would tolerate on their heads. Neckband 605 may also have a larger surface area over which to diffuse and disperse heat to the ambient environment. Thus, neckband 605 may allow for greater battery and computation capacity than might otherwise have been possible on a stand-alone eyewear device. Since weight carried in neckband 605 may be less invasive to a user than weight carried in eyewear device 602, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 605 may be communicatively coupled with eyewear device 602 and/or to other devices. These other devices may provide certain functions (e.g., tracking, localizing, depth mapping, processing, storage, etc.) to augmented-reality system 600. In the embodiment of FIG. 6, neckband 605 may include two acoustic transducers (e.g., 620(I) and 620(J)) that are part of the microphone array (or potentially form their own microphone subarray). Neckband 605 may also include a controller 625 and a power source 635.

Acoustic transducers 620(I) and 620(J) of neckband 605 may be configured to detect sound and convert the detected sound into an electronic format (analog or digital). In the embodiment of FIG. 6, acoustic transducers 620(I) and 620(J) may be positioned on neckband 605, thereby increasing the distance between the neckband acoustic transducers 620(I) and 620(J) and other acoustic transducers 620 positioned on eyewear device 602. In some cases, increasing the distance between acoustic transducers 620 of the microphone array may improve the accuracy of beamforming performed via the microphone array. For example, if a sound is detected by acoustic transducers 620(C) and 620(D) and the distance between acoustic transducers 620(C) and 620(D) is greater than, e.g., the distance between acoustic transducers 620(D) and 620(E), the determined source location of the detected sound may be more accurate than if the sound had been detected by acoustic transducers 620(D) and 620(E).

Controller 625 of neckband 605 may process information generated by the sensors on neckband 605 and/or augmented-reality system 600. For example, controller 625 may process information from the microphone array that describes sounds detected by the microphone array. For each detected sound, controller 625 may perform a direction-of-arrival (DOA) estimation to estimate a direction from which the detected sound arrived at the microphone array. As the microphone array detects sounds, controller 625 may populate an audio data set with the information. In embodiments in which augmented-reality system 600 includes an inertial measurement unit, controller 625 may compute all inertial and spatial calculations from the IMU located on eyewear device 602. A connector may convey information between augmented-reality system 600 and neckband 605 and between augmented-reality system 600 and controller 625. The information may be in the form of optical data, electrical data, wireless data, or any other transmittable data form. Moving the processing of information generated by augmented-reality system 600 to neckband 605 may reduce weight and heat in eyewear device 602, making it more comfortable to the user.

Power source 635 in neckband 605 may provide power to eyewear device 602 and/or to neckband 605. Power source 635 may include, without limitation, lithium ion batteries, lithium-polymer batteries, primary lithium batteries, alkaline batteries, or any other form of power storage. In some cases, power source 635 may be a wired power source. Including power source 635 on neckband 605 instead of on eyewear device 602 may help better distribute the weight and heat generated by power source 635.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 700 in FIG. 7, that mostly or completely covers a user's field of view. Virtual-reality system 700 may include a front rigid body 702 and a band 704 shaped to fit around a user's head. Virtual-reality system 700 may also include output audio transducers 706(A) and 706(B). Furthermore, while not shown in FIG. 7, front rigid body 702 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 600 and/or virtual-reality system 700 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 600 and/or virtual-reality system 700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 600 and/or virtual-reality system 700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 7, output audio transducers 706(A) and 706(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 6, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a prism that comprises or includes polycarbonate include embodiments where a prism consists essentially of polycarbonate and embodiments where a prism consists of polycarbonate.

What is claimed is:

1. A method comprising:
forming a first transflective mirror element and a separate second transflective mirror element;
forming a first functional coating over an active surface of the first transflective mirror element;
forming a second functional coating over an active surface of the second transflective mirror element; and
aligning the first transflective mirror element with the second transflective mirror element to form a microprism array.

2. The method of claim 1, wherein forming the first transflective mirror element and forming the second transflective mirror element comprise molding an optical polymer.

3. The method of claim 1, wherein a refractive index of the first transflective mirror element is substantially equal to a refractive index of the second transflective mirror element.

4. The method of claim 1, wherein forming the first transflective mirror element comprises molding a first optical polymer and forming the second transflective mirror element comprises molding a second optical polymer.

5. The method of claim 1, wherein forming the first and second functional coatings comprises evaporative deposition.

6. The method of claim 1, wherein forming the first functional coating comprises evaporative deposition in a first deposition process and forming the second functional coating comprises evaporative deposition in a second deposition process.

7. The method of claim 1, wherein a thickness of the first functional coating differs from a thickness of the second functional coating.

8. The method of claim 1, wherein an angle of inclination of the active surface of the first transflective mirror element is different than an angle of inclination of the active surface of the second transflective mirror element.

9. The method of claim 1, wherein the first transflective mirror element and the second transflective mirror element are aligned using a mating coupling feature.

10. The method of claim 1, wherein the first transflective mirror element comprises a female coupling feature, the second transflective mirror element comprises a male coupling feature, and the first transflective mirror element and the second transflective mirror element are aligned by engaging the female coupling feature with the male coupling feature.

11. The method of claim 1, wherein the first functional coating comprises a reflective polarizer having a first polarization response and the second functional coating comprises a reflective polarizer having a second polarization response different from the first polarization response.

12. A geometric waveguide comprising:
an expansion zone comprising an array of independently-configured first transflective mirror elements; and
an out-coupling zone comprising an array of independently-configured second transflective mirror elements.

13. The geometric waveguide of claim 12, wherein each first transflective mirror element comprises an active surface, and the active surfaces of the first transflective mirror element each comprise an optical coating.

14. The geometric waveguide of claim 13, wherein a thickness of the optical coatings is different amongst the first transflective mirror elements.

15. The geometric waveguide of claim 13, wherein an angle of inclination of the active surfaces of the first transflective mirror elements are different.

16. The geometric waveguide of claim 12, wherein each second transflective mirror element comprises an active surface, and the active surfaces of the second transflective mirror element each comprise an optical coating.

17. The geometric waveguide of claim 16, wherein a thickness of the optical coatings is different amongst the second transflective mirror elements.

18. The geometric waveguide of claim 16, wherein an angle of inclination of the active surfaces of the second transflective mirror elements are different.

19. A geometric waveguide comprising:
a first array of independently-configured transflective mirror elements; and
a second array of independently-configured transflective mirror elements.

20. The geometric waveguide of claim 19, wherein the first array of independently-configured transflective mirror elements comprises a plurality of facets, each facet having an active surface with an optical coating disposed over each active surface, and the second array of independently-configured transflective mirror elements comprises a plurality of facets, each facet having an active surface with an optical coating disposed over each active surface.
